(19) United States
(12) Patent Application Publication
(10) Pub. No.: US 2026/0331358 A1
(43) Pub. Date: Oct. 22, 2026

(54) COIL DEVICE

(71) Applicant: TDK Corporation, Tokyo (JP)

(72) Inventors: Tomoya ISHIHARA, Tokyo (JP); Toru TONOGAI, Tokyo (JP)

(73) Assignee: TDK Corporation, Tokyo (JP)

(21) Appl. No.: 19/695,607

(22) Filed: Jun. 2, 2026

(30) Foreign Application Priority Data
Mar. 6, 2025 (JP) 2025-092770

(51) Int. Cl. H01F 27/28; H01F 1/01; H01F 27/29; H01F 27/32

(52) U.S. Cl. CPC H01F 27/2852; H01F 1/01; H01F 27/292; H01F 27/323; H01F 2027/2861

(57) ABSTRACT

Provided is a coil device capable of preventing deterioration of an insulating member. A coil device includes a first conductor having a first electrode surface at an end portion of the first conductor; a second conductor having a second electrode surface at an end portion of the second conductor; an insulating member disposed between the first conductor and the second conductor; and an exterior member covering the first conductor and the second conductor such that at least the first electrode surface and the second electrode surface are exposed to an outside. A magnetic member is disposed on an outer side of an end portion of the insulating member that is close to the first electrode surface and the second electrode surface.

### BACKGROUND OF THE INVENTION

### 1. Field of the Invention

Priority is claimed on Japanese Patent Application No. 2025-092770, filed on Jun. 3, 2025, the entire content of which is incorporated herein by reference.

The present disclosure relates to a coil device.

### 2. Description of the Related Art

In a coil device used in a power supply circuit, load responsiveness that enables stable output of a constant voltage even under driving conditions in which a high current load changes rapidly is required. Patent Document 1 discloses a coil component that can be used in a high-current circuit through which a high current flow, and that can be miniaturized (reduction of a mounting region) on a mounting surface (board mounting surface) of a circuit board on which the coil component is mounted.

In a coil device through which a high current flows, leakage magnetic flux also tends to increase, and there is a demand for reducing leakage magnetic flux as much as possible. In particular, even if the location where leakage magnetic flux is generated is a minute region, the absolute amount of leakage magnetic flux becomes large when a high current flows, and therefore, it is desirable to reduce the leakage magnetic flux even to a small extent. In addition, such a high-current circuit is often applied to, for example, harsh environments such as power machinery or automobiles, and higher reliability is required.

### CITATION LIST

### Patent Document

Patent Document 1: JP 2022-66107 A

### SUMMARY OF THE INVENTION

An object of the present disclosure is to provide a coil device that reduces leakage magnetic flux and has high reliability.

A coil device according to the present disclosure includes a first conductor having a first electrode surface at an end portion of the first conductor; a second conductor having a second electrode surface at an end portion of the second conductor; an insulating member disposed between the first conductor and the second conductor; and an exterior member covering the first conductor and the second conductor such that at least the first electrode surface and the second electrode surface are exposed to an outside. A magnetic member is disposed on an outer side of an end portion of the insulating member that is close to the first electrode surface and the second electrode surface.

### BRIEF DESCRIPTION OF THE DRAWINGS

FIG. 1A is a transparent perspective view of a coil device according to one embodiment of the present disclosure as viewed obliquely from above;

FIG. 1B is a bottom view of the coil device illustrated in FIG. 1A;

FIG. 1C is a cross-sectional view of the coil device illustrated in FIG. 1A, taken along line IC-IC in FIG. 1A;

FIG. 1D is a partial cross-sectional view of the coil device illustrated in FIG. 1A, and is a cross-sectional view of a portion ID in FIG. 1C;

FIG. 2A is a flowchart illustrating one example of a method for manufacturing a coil device according to the present disclosure;

FIG. 2B is a first view for explaining the method for manufacturing a coil device illustrated in FIG. 2A;

FIG. 2C is a second view for explaining the method for manufacturing a coil device illustrated in FIG. 2A;

FIG. 2D is a third view for explaining the method for manufacturing a coil device illustrated in FIG. 2A;

FIG. 3A is a first view illustrating a first modification example of the coil device according to the present disclosure;

FIG. 3B is a second view illustrating the first modification example of the coil device according to the present disclosure, and is a cross-sectional view taken along line IIIB-IIIB in FIG. 3A;

FIG. 4 is a view illustrating a second modification example of the coil device according to the present disclosure;

FIG. 5A is a first view illustrating a third modification example of the coil device according to the present disclosure;

FIG. 5B is a second view illustrating the third modification example of the coil device according to the present disclosure, and is a cross-sectional view taken along line VB-VB in FIG. 5A;

FIG. 6 is a view illustrating a fourth modification example of the coil device according to the present disclosure;

FIG. 7A is a view illustrating a fifth modification example of the coil device according to the present disclosure; and

FIG. 7B is a view illustrating a sixth modification example of the coil device according to the present disclosure.

### DETAILED DESCRIPTION OF THE PREFERRED EMBODIMENTS

Hereinafter, embodiments of the present disclosure will be described with reference to the drawings. The embodiments described below are provided by way of example to explain the present disclosure, and the present disclosure is not limited to the following embodiments. Features of various constituents of the following embodiments, for example, numerical values, shapes, materials, and manufacturing processes, and the like can be modified or changed to the extent that no technical problems arise. In addition, the contents illustrated in the drawings are merely shown schematically and exemplarily for understanding of the present disclosure, and the appearance, dimensional ratios, or the like may differ from those of actual products.

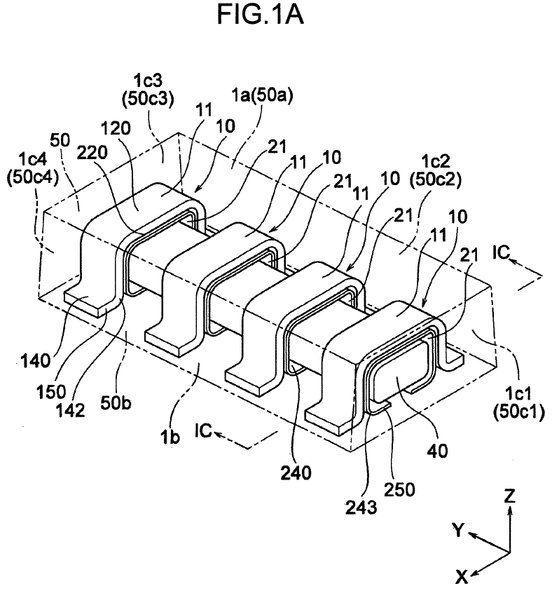

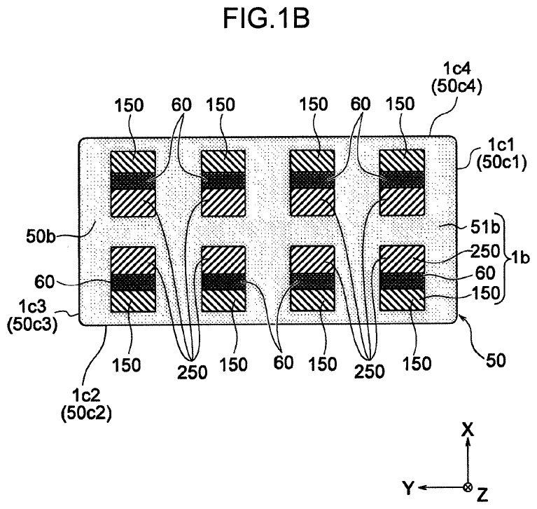

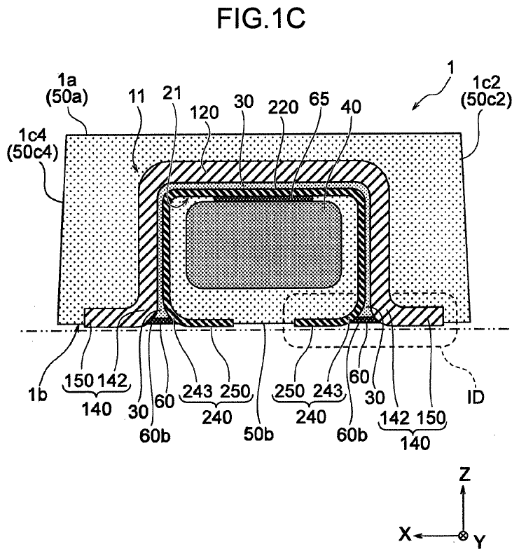

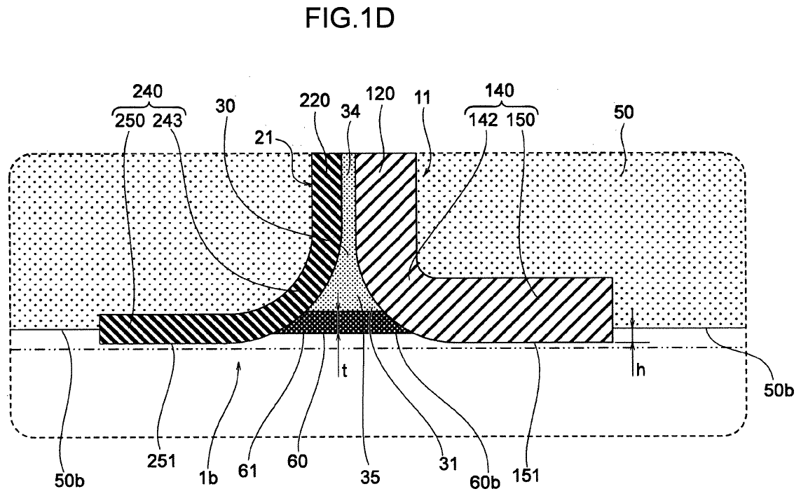

As one embodiment of the present disclosure, a coil device 1 suitable for use as a coupling coil in power supply circuits of various electrical devices will be described with reference to FIGS. 1A to 1D.

As illustrated in FIG. 1A, the coil device 1 is a substantially rectangular parallelepiped-shaped (hexahedron-shaped) electronic component having a top surface 1a, a bottom surface 1b, and four first to fourth side surfaces 1c1 to 1c4 connecting the top surface 1a and the bottom surface 1b. The bottom surface 1b is, for example, a surface disposed to face a mounting surface (board mounting surface) of a circuit board or the like, and the coil device 1 is electrically connected to an external circuit on the circuit board via an electrode surface (which will be described later) disposed on the bottom surface 1b. In this sense, the bottom surface 1b may also be referred to as a mounting-side surface.

In the present disclosure, a direction in which the second side surface 1c2 and the fourth side surface 1c4 face each other is defined as an X-axis direction, a direction in which the first side surface 1c1 and the third side surface 1c3 face each other is defined as a Y-axis direction, and a direction in which the bottom surface 1b and the top surface 1a face each other is defined as a Z-axis direction. The X-axis, the Y-axis, and the Z-axis are perpendicular to each other. In addition, a direction from the second side surface 1c2 toward the fourth side surface 1c4, a direction from the first side surface 1c1 toward the third side surface 1c3, and a direction from the bottom surface 1b toward the top surface 1a are referred to as positive directions of the X-axis, the Y-axis, and the Z-axis, respectively, and directions opposite to the positive directions of the respective axes are referred to as negative directions of the X-axis, the Y-axis, and the Z-axis. In addition, the Z-axis direction may also be referred to as a vertical direction, and a direction parallel to the X-Y plane may also be referred to as a horizontal direction. Further, the positive direction of the Z-axis may also be referred to as an upward direction or upward, and the negative direction of the Z-axis may also be referred to as a downward direction or downward.

The size of the coil device 1 is not particularly limited; however, for example, the length (width) of the coil device 1 in the X-axis direction is 1 mm to 40 mm, the length (length or depth) of the coil device 1 in the Y-axis direction is 1 mm to 100 mm, and the length (height) of the coil device 1 in the Z-axis direction is 0.5 mm to 20 mm.

As illustrated in FIG. 1A, the coil device 1 includes a plurality of (four in the present embodiment) conductor assemblies 10, . . . , 10 arranged in parallel along the Y-axis direction; a single center core 40 disposed so as to penetrate through the interiors of the plurality of conductor assemblies 10, . . . , 10; and an exterior member 50 that integrally covers the plurality of conductor assemblies 10, . . . , 10 and the single center core 40. The exterior member 50 covers the entirety of the coil device 1, excluding portions of a first electrode surface 151 and a second electrode surface 251 (which will be described later) exposed to the outside.

As illustrated in FIG. 1C, each of the conductor assemblies 10 includes a first conductor 11 having a portion that is substantially U-shaped in plan view (shape in the X-Z plane) as viewed in the Y-axis direction; a second conductor 21 having a substantially U-shaped portion similar to that of the first conductor 11 and disposed inside the first conductor 11, the majority of the second conductor 22 extending along the first conductor 11; an insulating member 30 covering the first conductor 11 and the second conductor 21; and a magnetic member 60 disposed on an outer side (the mounting-side surface side, that is, the bottom surface 1b side) of the insulating member 30.

In the present embodiment, the first conductor 11 functions as a primary coil, and the second conductor 21 functions as a secondary coil; however, the present invention is not limited to this configuration. The second conductor 21 may function as a primary coil, and the first conductor 11 may function as a secondary coil.

The first conductor 11 is formed of an elongated flat plate-shaped (longitudinally elongated flat plate-shaped) conductor plate, and includes a body portion 120 forming a substantially U-shaped center portion, and end portions 140 and 140 that are formed so as to be continuous with end portions on both sides of the body portion 120 in the extending direction (longitudinal direction) of the conductor plate. However, the first conductor 11 is not limited to a longitudinally elongated flat plate-shaped conductor plate, and may be formed of a conductive wire having any cross-sectional shape (a round wire having a circular cross-section, a rectangular wire having a rectangular cross-section, or the like).

Each of the end portions 140 and 140 includes an outwardly bent portion 142 that is continuous with the end portion of the body portion 120, and an electrode terminal 150 that is continuously formed further toward the end portion side of the first conductor 11 with respect to the outwardly bent portion 142.

The outwardly bent portions 142 are portions which are continuous with vertical portions on both sides of the body portion 120 having a substantially U-shape, and in which the extending direction of the first conductor 11 is bent by 90 degrees from a vertically downward direction to a horizontally outward direction. That is, each of the outwardly bent portions 142 is continuous with an end portion of a portion of the body portion 120, the portion extending downward in the Z-axis direction, changes the extending direction by 90 degrees toward the outside of the coil device 1 in the X-axis direction, and is connected to the first terminal portion 150.

The first terminal portion 150 is formed so as to be continuous with a further end portion of the first conductor 11 that is bent by the outwardly bent portion 142 such that the extending direction is aligned with the X-axis direction, and to extend a predetermined length in a direction substantially parallel to the bottom surface 1b of the coil device 1. The first terminal portion 150 protrudes downward from an exterior member bottom surface 50b and a magnetic member bottom surface 60b (which will be described later) by a predetermined thickness (height) in a thickness direction (Z-axis direction), and extends along the bottom surface 1b of the coil device 1, and a surface exposed to the outside forms the first electrode surface 151.

It should be noted that the first electrode surface 151 may not protrude from the exterior member bottom surface 50b or the magnetic member bottom surface 60b, and may be an exposed surface that is flush with the exterior member bottom surface 50b and the magnetic member bottom surface 60b, or the first electrode surface 151 may be formed as an exposed surface recessed from the exterior member bottom surface 50b or the magnetic member bottom surface 60b.

The first conductor 11 is entirely covered by the exterior member 50 along the longitudinal direction; however, only the first electrode surfaces 151 and 151 of the first terminal portions 150 and 150 of both end portions 140 and 140 are not covered by the exterior member 50 and the like and are exposed to the outside. The first electrode surface 151 may be formed with the first conductor 11 exposed as it is; however, the first electrode surface 151 may be formed with plating or the like applied to the element body surface of the first conductor 11.

The first electrode surfaces 151 and 151 of the first terminal portions 150 and 150 formed at both ends of the first conductor 11 are connected to, for example, respective lands or the like, which are disposed on the mounting surface (board mounting surface) of the circuit board on which an external circuit is formed, by joining members such as solder or a conductive adhesive, thereby electrically connecting the first conductor 11 to the external circuit. In addition, accordingly, the coil device 1 is mechanically installed on the circuit board or the like.

Examples of a material for the conductor plate constituting the first conductor 11 include good conductors of metals such as copper, copper alloys, silver, and nickel; however, the material is limited thereto as long as the material is a conductive material. For example, the thickness of the first conductor 11 is 0.1 mm to 2.5 mm, the width of the first conductor 11 is 0.1 mm to 5 mm, and the entire plate length of the first conductor 11 in the longitudinal direction is 1 mm to 100 mm.

The first conductor 11 is formed, for example, by machining (bending) such a conductor plate; however, the method for forming the first conductor 11 is not limited thereto. In addition, in the first conductor 11 of the present embodiment, as illustrated in FIG. 1C, the length (width) thereof in the X-axis direction is longer than the length (height) thereof in the Z-axis direction, and the first conductor 11 is formed in an overall flat shape. However, the first conductor 11 may be formed in a tall shape in which the length (height) in the Z-axis direction is longer than the length (width) in the X-axis direction.

A plating layer may be formed on the periphery of the conductor plate of the first conductor 11. The plating layer may be a single layer or a multilayer, and may be formed of, for example, a metal plating layer such as Cu plating, Ni plating, Sn plating, Ag plating, Ni—Sn plating, Cu—Ni—Sn plating, Ni—Au plating, or Au plating. The plating layer is formed, for example, by applying electroplating or electroless plating to the surface of the conductor plate serving as the base material of the first conductor 11. The thickness of the plating layer is not particularly limited, but is preferably 0.05 μm to 30 μm.

The second conductor 21 is formed of an elongated flat plate-shaped (longitudinally elongated flat plate-shaped) conductor plate, and includes a body portion 220 forming a substantially U-shaped center portion, and end portions 240 and 240 that are formed so as to be continuous with end portions on both sides of the body portion 220 in the extending direction (longitudinal direction) of the conductor plate. The body portion 220 is disposed inside the first conductor 11 so as to extend along the body portion 120 of the first conductor 11 with a predetermined spacing from the body portion 120 of the first conductor 11. Similarly to the first conductor 11, the second conductor 21 is also not limited to a longitudinally elongated flat plate-shaped conductor plate, and may be formed of a conductive wire having any cross-sectional shape (a round wire having a circular cross-section, a rectangular wire having a rectangular cross-section, or the like).

Each of the end portions 240 and 240 includes an inwardly bent portion 243 that is continuous with the end portion of the body portion 220, and an electrode terminal 250 that is continuously formed further toward the end portion side of the second conductor 21 with respect to the inwardly bent portion 243.

The inwardly bent portions 243 are portions which are continuous with vertical portions on both sides of the body portion 220 having a substantially U-shape, and in which the extending direction of the second conductor 21 is bent by 90 degrees from the vertically downward direction to a horizontally inward direction. That is, each of the inwardly bent portions 243 is continuous with an end portion of a portion of the body portion 220, the portion extending downward in the Z-axis direction, changes the extending direction by 90 degrees toward the inside of the coil device 1 in the X-axis direction, and is connected to the second terminal portion 250.

The second terminal portion 250 is formed so as to be continuous with a further end portion of the second conductor 21 that is bent by the inwardly bent portion 243 such that the extending direction is aligned with the X-axis direction, and to extend a predetermined length in a direction substantially parallel to the bottom surface 1b of the coil device 1. The second terminal portion 250 protrudes downward from the exterior member bottom surface 50b and the magnetic member bottom surface 60b (which will be described later) by a predetermined thickness (height) in the thickness direction (Z-axis direction), and extends along the bottom surface 1b of the coil device 1, and a surface exposed to the outside forms the second electrode surface 251.

It should be noted that the second electrode surface 251 may not protrude from the exterior member bottom surface 50b or the magnetic member bottom surface 60b, and may be an exposed surface that is flush with the exterior member bottom surface 50b and the magnetic member bottom surface 60b, or the second electrode surface 251 may be formed as an exposed surface recessed from the exterior member bottom surface 50b or the magnetic member bottom surface 60b.

The second conductor 21 is entirely covered by the exterior member 50 along the longitudinal direction; however, only the second electrode surfaces 251 and 251 of the second terminal portions 250 and 250 of both end portions 240 and 240 are not covered by the exterior member 50 and the like and are exposed to the outside. The second electrode surface 251 may be formed with the second conductor 21 exposed as it is; however, the second electrode surface 251 may be formed with plating or the like applied to the element body surface of the second conductor 21.

The second electrode surfaces 251 and 251 of the second terminal portions 250 and 250 formed at both ends of the second conductor 21 are connected to, for example, respective lands or the like, which are disposed on the mounting surface (board mounting surface) of the circuit board on which an external circuit is formed, by joining members such as solder or a conductive adhesive, thereby electrically connecting the second conductor 21 to the external circuit. In addition, accordingly, the coil device 1 is mechanically installed on the circuit board or the like.

Examples of a material for the conductor plate constituting the second conductor 21 include good conductors of metals such as copper, copper alloys, silver, and nickel; however, the material is limited thereto as long as the material is a conductive material. For example, the thickness of the second conductor 21 is 0.1 mm to 2.5 mm, the width of the second conductor 21 is 0.1 mm to 5 mm, and the entire plate length of the second conductor 21 in the longitudinal direction is 1 mm to 100 mm. The thickness, width, and length of the second conductor 21 may be substantially the same as those of the first conductor 11, or may be greater (thicker, wider, longer) than those of the first conductor 11, or may be smaller (thinner, narrower, shorter) than those of the first conductor 11.

In the present embodiment, as is apparent from FIG. 1C and the like, the thickness of the second conductor 21 is thinner than the thickness of the first conductor 11, and is 1/10 to ½ of the thickness of the first conductor 11.

The second conductor 21 is formed, for example, by machining (bending) such a conductor plate; however, the method for forming the second conductor 21 is not limited thereto. In addition, in the second conductor 21 of the present embodiment, as illustrated in FIG. 1C, the length (width) thereof in the X-axis direction is longer than the length (height) thereof in the Z-axis direction, and the second conductor 21 is formed in an overall flat shape. However, the second conductor 21 may be formed in a tall shape in which the length (height) in the Z-axis direction is longer than the length (width) in the X-axis direction.

A plating layer may be formed on the periphery of the conductor plate of the second conductor 21. The plating layer may be a single layer or a multilayer, and may be formed of, for example, a metal plating layer such as Cu plating, Ni plating, Sn plating, Ag plating, Ni—Sn plating, Cu—Ni—Sn plating, Ni—Au plating, or Au plating. The plating layer is formed, for example, by applying electroplating or electroless plating to the surface of the conductor plate serving as the base material of the second conductor 21. The thickness of the plating layer is not particularly limited, but is preferably 0.05 μm to 30 μm.

To summarize the similarities and differences in shape and the disposition relationship between the first conductor 11 and the second conductor 21 of the present embodiment, the shapes of the body portions 120 and 220 of the first conductor 11 and the second conductor 21 are substantially the same; however, the extending directions of the end portions 140 and 140 and the end portions 240 and 240 thereof are different.

The first conductor 11 and the second conductor 21 have substantially the same width (length in the Y-axis direction), and the length (length along the extending direction) of the first conductor 11 is longer than that of the second conductor 21 by an amount corresponding a portion at which the body portion 120 of the first conductor 11 is bent on the outer peripheral side of the body portion 220 of the second conductor 21. In addition, as described above, the thickness of the second conductor 21 is thinner than the thickness of the first conductor 11, and is 1/10 to ½ of the thickness of the first conductor 11.

The body portion 220 of the second conductor 21 is one size smaller in the X-Z plane than the body portion 120 of the first conductor 11, and is disposed inside the first conductor 11. That is, the second conductor 21 is disposed inside the body portion 120 of the first conductor 11 at the body portion 220, and extends along the body portion 120 of the first conductor 11, in other words, parallel to the body portion 120 of the first conductor 11, and in still other words, so as to face the body portion 120 of the first conductor 11.

A space (gap) between the body portion 120 of the first conductor 11 and the body portion 220 of the second conductor 21 is formed as an insulating gap portion 34 for ensuring insulation between the first conductor 11 and the second conductor 21. The thickness of the insulating gap portion 34, that is, the spacing between the body portion 120 of the first conductor 11 and the body portion 220 of the second conductor 21 facing the body portion 120 is substantially uniform throughout the entirety of the body portions 120 and 220, and from the viewpoint of ensuring insulation, the thickness of the insulating gap portion 34 is, for example, 5 μm or more, and may be 10 μm to 2 mm.

Portions of the end portions 140 and 140 of the first conductor 11, the portions being continuous with the body portion 120, are bent with a predetermined curvature (radius of curvature) toward the outside of the coil device 1 (in a direction in which the pair of end portions 140 and 140 are disposed back-to-back along the X-axis direction) at the locations of the outwardly bent portions 142 and 142. The first conductor 11 is bent at the outwardly bent portions 142 and 142 such that the extending direction is finally changed at substantially a right angle toward the outside, and the first terminal portions 150 and 150 are formed at end portions at which the extending direction is parallel to the X-axis direction.

On the other hand, portions of the end portions 240 and 240 of the second conductor 21, the portions being continuous with the body portion 220, are bent at substantially a right angle toward the inside of the coil device 1 (in a direction in which the pair of end portions 240 and 240 face each other along the X-axis direction) at the locations of the inwardly bent portions 243 and 243. The second conductor 21 is bent at the inwardly bent portions 243 and 243 such that the extending direction is finally changed at substantially a right angle toward the inside, and the second terminal portions 250 and 250 are formed at end portions at which the extending direction is parallel to the X-axis direction.

Accordingly, the first terminal portions 150 and 150 of the first conductor 11 and the second terminal portions 250 and 250 of the second conductor 21 can be disposed on the same plane (X-Y plane) along the bottom surface 1b of the coil device 1. In other words, accordingly, the first terminal portions 150 and 150 at both end portions of the first conductor 11 and the second terminal portions 250 and 250 at both end portions of the second conductor 21 are disposed so as to be exposed to the outside on the same plane along the bottom surface 1b of the coil device 1, and form a part of the mounting-side surface of the coil device 1.

As illustrated in FIG. 1D, an expanded spacing portion 35 in which a spacing between the first conductor 11 and the second conductor 21 is larger than a spacing between the first conductor 11 and the second conductor 21 in the body portions 120 and 220 is formed between the outwardly bent portion 142 of the first conductor 11 and the inwardly bent portion 243 of the second conductor 21. The spacing between the outwardly bent portion 142 of the first conductor 11 and the inwardly bent portion 243 of the second conductor 21 gradually increases from a location connected to the insulating gap portion 34 on a side away from the bottom surface 1b of the coil device 1 toward the bottom surface 1b of the coil device 1.

In the present embodiment, the insulating gap portion 34 and the insulating gap portion 34 side of the expanded spacing portion 35 are filled with the insulating member 30, and the magnetic member 60 is disposed at an end portion of the insulating member 30 disposed in the insulating gap portion 34, that is, at the end portion on the side closest to the bottom surface 1b of the coil device 1 so as to cover the insulating gap portion 34. The magnetic member 60 will be described in detail later.

The insulating member 30 is formed of an insulating material and, as illustrated in FIG. 1C, is disposed between the first conductor 11 and the second conductor 21 to ensure insulation between the first conductor 11 and the second conductor 21 (prevent a short circuit). The insulating member 30 is disposed throughout the entire region of the insulating gap portion 34 between the body portion 120 of the first conductor 11 and the body portion 220 of the second conductor 21, and in a part of the expanded spacing portion 35 between the outwardly bent portion 142 of the first conductor 11 and the inwardly bent portion 243 of the second conductor 21.

In addition to an insulating function, the insulating member 30 may also function to bond the first conductor 11 and the second conductor 21. For example, the insulating member 30 may be formed from an adhesive resin. The first conductor 11 and the second conductor 21 can be firmly fixed and coupled by forming the insulating member 30 from an adhesive resin and interposing the insulating member 30 between the first conductor 11 and the second conductor 21 as described above, thereby being able to improve the durability and stability of the characteristics of the first conductor 11. In addition, the manufacturing process of the coil device 1 can be simplified by bonding the first conductor 11 and the second conductor 21 with the insulating member 30 and relatively fixing the first conductor 11 and the second conductor 21 before a sealing step using the exterior member 50 in the manufacturing process of the coil device 1.

As illustrated in FIG. 1D, the insulating member 30 is disposed in a part on the insulating gap portion 34 side (the side away from the bottom surface 1b of the coil device 1) of the expanded spacing portion 35, and is not disposed throughout the entire region of the expanded spacing portion 35. In the expanded spacing portion 35, the magnetic member 60 (which will be described later) is disposed on the bottom surface 1b side of the coil device 1 with respect to the insulating member 30.

In the present embodiment, the insulating member 30 is disposed throughout the entire disposition range described above, that is, the entire range of the insulating gap portion 34 and a predetermined range on the insulating gap portion 34 side of the expanded spacing portion 35. However, the insulating member 30 may be disposed only in a part of the disposition range described above. For example, the insulating member 30 may be intermittently disposed along the extending direction of the first conductor 11 and the second conductor 21, or may be disposed partially in the width direction of the first conductor 11 and the second conductor 21 or intermittently in the width direction as well. A portion in which the insulating member 30 is not disposed may be a void, or may be filled with the exterior member 50 (which will be described later).

The material forming the insulating member 30 is not particularly limited; however, examples of the material include resin materials such as polyester, polyesterimide, polyamide, polyamideimide, polyurethane, epoxy, and epoxy-modified acrylic resins. In addition, the insulating member 30 may be air. That is, a configuration may be adopted in which a void is formed between the first conductor 11 and the second conductor 21 and the void serves as the insulating member 30. In the configuration in which air serves as the insulating member 30, the entire disposition region of the insulating member 30 illustrated in FIG. 1C may be filled with air, or a space filled with air may be formed partially between the first conductor 11 and the second conductor 21. In the latter configuration, the resin material described above may be disposed as an insulating member in regions other than the space filled with air.

The center core 40 is a ferromagnetic member that is disposed inside the second conductors 21, . . . , 21 so as to span across the plurality of conductor assemblies 10, . . . , 10 in order to increase the inductance of the coil device 1.

In the present embodiment, the center core 40 is a power compact containing soft magnetic metal particles and a resin. The center core 40 is obtained, for example, by mixing soft magnetic metal powder and a resin, filling a die with granules obtained by granulating the mixture, and applying pressure. However, the material of the center core 40 is not limited thereto, and may be a sintered metal or a ceramic such as a ferrite material.

The axial length (length in the Y-axis direction in FIG. 1) of the center core 40 may be substantially the same as the arrangement length of the plurality of (four) conductor assemblies 10, . . . , 10, or may be longer or shorter than the arrangement length.

There are no particular restrictions on the material and shape of the soft magnetic metal particles forming the center core 40. In addition, the resin forming the center core 40 is not particularly limited; however, examples of the resin include epoxy resin, phenolic resin, polyimide resin, polyamideimide resin, and silicone resin. In addition, a resin obtained by appropriately combining these resins may be prepared.

The exterior member 50 is a member that integrally covers the plurality of conductor assemblies 10, . . . , 10 and forming the outer shape of the coil device 1. As illustrated in FIG. 1A, the exterior member 50 has a top surface 50a; a bottom surface 50b facing the top surface 50a; and first to fourth side surfaces 50c1 to 50c4 connecting the bottom surface 50b and the top surface 50a. The outer shape of the exterior member 50 is a substantially rectangular parallelepiped-shaped hexahedron, but is not limited to a hexahedron, and may be another polyhedron such as an octahedron, a columnar shape such as a circular column shape, or a three-dimensional shape in which a bottom surface and a top surface are not congruent, such as a truncated cone.

The top surface 1a and the first to fourth side surfaces 1c1 to 1c4 of the coil device 1 are formed by the top surface 50a and the first to fourth side surfaces 50c1 to 50c4 of the exterior member 50. That is, the first to fourth sides 1c1 to 1c4 of the coil device 1 are identical to the first to fourth sides 50c1 to 50c4 of the exterior member 50.

On the other hand, as illustrated in FIG. 1B, the mounting-side surface (bottom surface) 1b of the coil device 1 includes, in addition to the bottom surface 50b of the exterior member 50, a pair of the first terminal portions 150 and 150 of the first conductor 11, a pair of the second terminal portions 250 and 250 of the second conductor 21, and the magnetic member 60 (which will be described later) between the first terminal portion 150 and the second terminal portion 250 corresponding to the magnetic member 60.

As illustrated in FIG. 1C, the exterior member 50 is configured to cover the conductor assemblies 10, . . . , 10 to form the outer shape of the coil device 1, and to extend through spaces between the interiors of the second conductors 21 of the conductor assemblies 10, . . . , 10 and the center core 40, in other words, to fill every corner of the interior of the coil device 1.

The exterior member 50 is formed from an exterior material containing magnetic particles and a resin, and may be formed using a magnetic material having a relatively high magnetic permeability. For example, an Fe-based soft magnetic material can be used as the exterior material constituting the exterior member 50. The coil device 1 including such an exterior member 50 has a high withstand voltage, and is capable of handling high current loads. Alternatively, the material of the exterior member 50 may be produced, for example, by molding and sintering magnetic powder composed of Ni—Zn ferrite, Mn—Zn ferrite, or a metal magnetic material.

The particle size of the magnetic particles forming the exterior member 50 is not particularly limited, but is, for example, 1 μm to 50 μm. The resin forming the exterior member 50 is not particularly limited, but is, for example, a thermosetting resin such as epoxy resin or phenolic resin. The relative magnetic permeability of the exterior member 50 is not particularly limited, but is, for example, 1 to 20000.

The magnetic member 60 is disposed along the bottom surface 1b of the coil device 1 between the first electrode surface 151 and the second electrode surface 251 (as illustrated in FIG. 1B, in a portion between the first electrode surface 151 and the second electrode surface 251 along the X-axis direction), and prevents an end portion 31 of the insulating member 30 from being exposed to the outside.

As illustrated in FIG. 1D, the magnetic member 60 is disposed on the outer side of the insulating member 30, that is, on the mounting-side surface 1b side of the insulating member 30, in still other words, on a side of the insulating member 30 closer to the first electrode surface 151 and the second electrode surface 251. In the present embodiment, as described above, the expanded spacing portion 35 in which the spacing between the first conductor 11 and the second conductor 21 is larger than the spacing between the first conductor 11 and the second conductor 21 in the body portions 120 and 220 is formed between the outwardly bent portion 142 of the first conductor 11 and the inwardly bent portion 243 of the second conductor 21, and the magnetic member 60 is disposed on an outer side of the expanded spacing portion 35. The magnetic member 60 is continuously formed on the expanded spacing portion 35 between the first electrode surface 151 and the second electrode surface 251.

As illustrated in FIG. 1B, the magnetic member 60 is formed so as to be continuous with the first electrode surface 151 and the second electrode surface 251 in the X-axis direction, that is, to be connected to the first electrode surface 151 and the second electrode surface 251. On the other hand, in the Y-axis direction perpendicular thereto, that is, in the arrangement direction of the plurality of conductor assemblies 10, . . . , 10, the magnetic member 60 is formed integrally with the exterior member 50 so as to be continuous with the bottom surface 50b of the exterior member 50 that constitutes the bottom surface 1b of the coil device 1, that is, to be connected to the bottom surface 50b of the exterior member 50.

As illustrated in FIG. 1D, the magnetic member 60 has an exposed surface 61 substantially parallel to the first electrode surface 151 of the first conductor 11, the second electrode surface 251 of the second conductor 21, and the bottom surface 50b of the exterior member 50. The exposed surface 61 of the magnetic member 60, the first electrode surface 151, the second electrode surface 251, and the bottom surface 50b of the exterior member 50 are continuous with each other along the bottom surface 1b of the coil device 1 (in the X-Y plane).

In addition, the exposed surface 61 of the magnetic member 60 and the bottom surface 50b of the exterior member 50 are formed so as to be substantially flush with each other in a height direction (Z-axis direction), and the first electrode surface 151 and the second electrode surface 251 are formed so as to be substantially flush with each other in the height direction (Z-axis direction). However, the first electrode surface 151 and the second electrode surface 251 protrude by a predetermined height h with respect to the exposed surface 61 of the magnetic member 60 and the bottom surface 50b of the exterior member 50, and are not flush therewith. In other words, the exposed surface 61 of the magnetic member 60 is recessed from the first electrode surface 151 and the second electrode surface 251 in the height direction (Z-axis direction).

Similarly to the exterior member 50, an Fe-based soft magnetic material can be used as the material of the magnetic member 60. Alternatively, the material of the magnetic member 60 may be produced, for example, by molding and sintering magnetic powder composed of Ni—Zn ferrite, Mn—Zn ferrite, or a metal magnetic material.

The thickness t of the magnetic member 60 may be greater than the particle size of the metal powder contained in the magnetic member 60, and may be thinner than the thickness of the second conductor 21. Specifically, the thickness t of the magnetic member 60 may be, for example, 5 μm to 50 μm, preferably 10 μm to 40 μm, and more preferably 20 μm to 30 μm.

Since a resin material containing metal magnetic powder is used as the material of the magnetic member 60 while a resin material is used as the material of the insulating member 30, the magnetic member 60 generally has a higher thermal conductivity. In other words, a configuration in which the magnetic member 60 has a higher thermal conductivity is easily adopted. As a result, the heat dissipation effect of the coil device 1 can be enhanced.

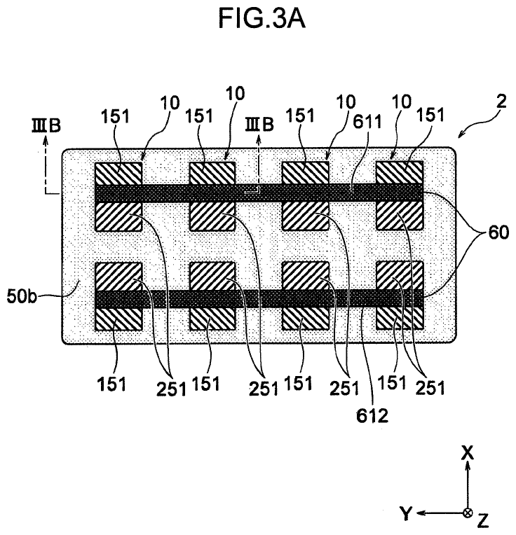

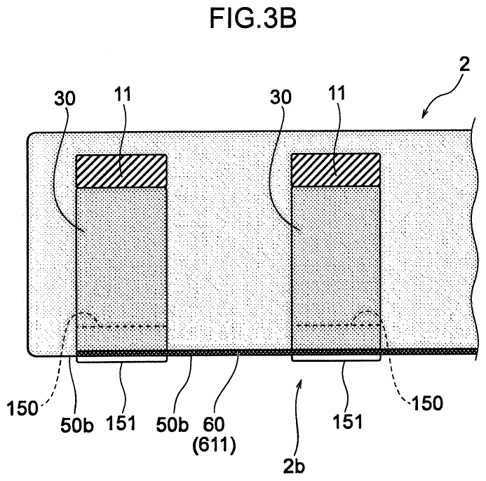

It should be noted that, as will be described later as modification examples of the present embodiment with reference to FIGS. 3A to 6, the magnetic member 60 may be formed on the bottom surface 1b of the coil device 1 not only in a region outside the end portion 31 of the insulating member 30 between the first electrode surface 151 and the second electrode surface 251, but also in other regions. That is, the magnetic member 60 may be disposed on the outer side of a part or the entirety of the bottom surface 50b of the exterior member 50. In such a configuration, the magnetic member 60 is formed integrally with the exterior member 50 so as to be continuous with the exterior member 50 in an up-down direction (Z-axis direction) as well, that is, to be connected to the exterior member 50.

The coil device 1 of the present embodiment has such a configuration.

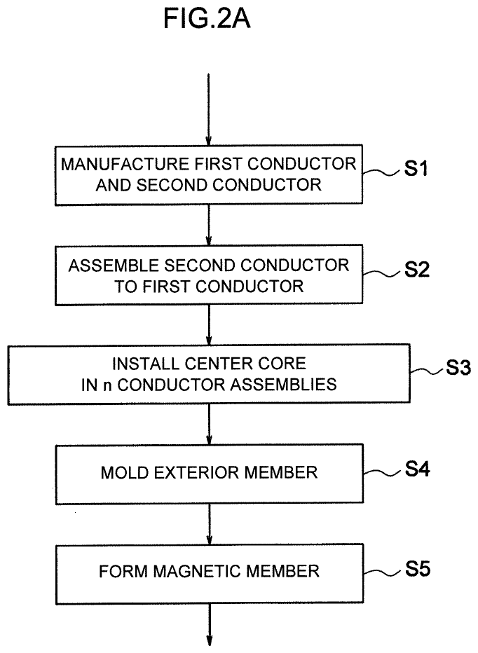

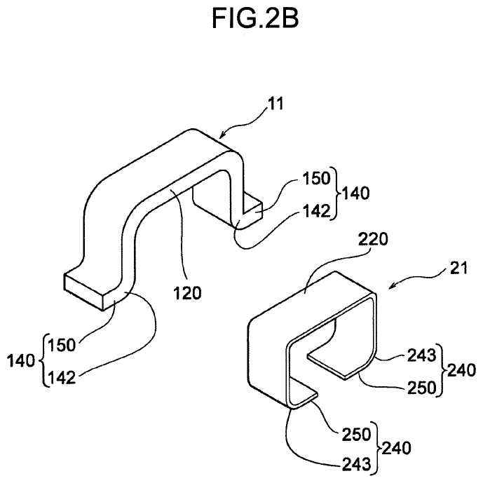

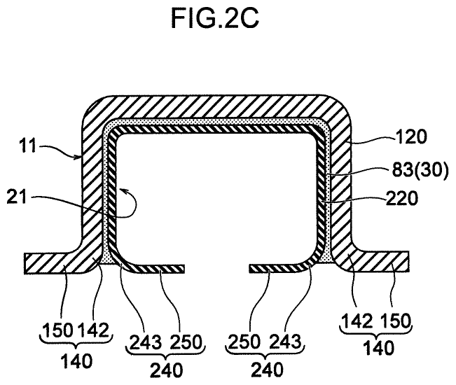

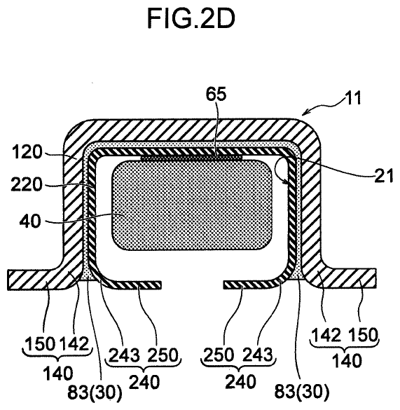

Next, one example of a method for manufacturing the coil device 1 according to the present disclosure will be described with reference to FIGS. 2A to 2D. FIG. 2A is a flowchart illustrating one example of the method for manufacturing the coil device 1 according to the present disclosure. It should be noted that the manufacturing method described herein is merely one example of the method for manufacturing the coil device 1, and the method for manufacturing the coil device 1 is not limited in any way to the method described below.

In the manufacturing process of the coil device 1, first, as illustrated in FIG. 2B, the first conductor 11 and the second conductor 21 are manufactured (step S1). Specifically, for example, the first conductor 11 including the body portion 120 and the end portions 140 and 140 is manufactured, for example, by bending an elongated flat plate (longitudinally elongated flat plate) for the first conductor 11 having a predetermined length, width, and thickness to appropriately form bent portions. In addition, the second conductor 21 including the body portion 220 and the end portions 240 and 240 is manufactured, for example, by bending an elongated flat plate (longitudinally elongated flat plate) for the second conductor 21 having a predetermined length, width, and thickness to appropriately form bent portions.

Next, as illustrated in FIG. 2C, the second conductor 21 is assembled to the first conductor 11 (step S2). Specifically, for example, the conductor assembly 10 in which the second conductor 21 is integrally assembled inside the first conductor 11 is formed by applying a material 83 for the insulating member 30 functioning as an adhesive to the inner surface of the body portion 120 of the first conductor 11, and disposing the second conductor 21 inside the first conductor 11 so as to overlap the first conductor 11. A plurality of the conductor assemblies 10, . . . , 10 are formed.

Next, as illustrated in FIG. 2D, the center core 40 is installed inside the plurality of conductor assemblies 10, . . . , 10, that is, inside the second conductors 21, . . . , 21 of the conductor assemblies 10, . . . , 10 (step S3). The installation of the center core 40 is performed, for example, as follows.

First, the plurality of conductor assemblies 10, . . . , 10 (four conductor assemblies 10, . . . , 10 in the present embodiment) constituting a single coil device 1 are arranged with a predetermined spacing. At this time, the plurality of conductor assemblies 10, . . . , 10 are arranged on a predetermined support or pedestal so as to be temporarily fixed by adhesive tape or the like such that opening portions inside the second conductors 21 are continuous in a predetermined direction (Y-axis direction and see FIG. 1).

Next, an adhesive 65 (see FIG. 1C) is applied to the upper inner peripheral surface of the second conductor 21 of each of the conductor assemblies 10, . . . , 10. For example, the same material as the insulating member 30 may be used as the adhesive 65.

Next, the center core 40 is inserted so as to penetrate through the interiors of the four conductor assemblies 10, . . . , 10, and the center core 40 is pressed against the upper inner peripheral surfaces of the second conductors 21. As a result, as illustrated in FIG. 1A, the center core 40 is installed by the adhesive 65, which is applied to the upper inner peripheral surfaces of the second conductors 21, so as to span across the four conductor assemblies 10, . . . , 10, that is, to penetrate through the interiors of the four conductor assemblies 10, . . . , 10.

It should be noted that the adhesive 65 may be applied not only to the upper inner peripheral surface of the second conductor 21, but also to the inner peripheral surfaces of the side surfaces or the inner peripheral surfaces of the end portions 240 and 240. In other words, the adhesive 65 may be applied over substantially the entire periphery of the center core 40. That is, when the spacing between the outer peripheral surface of the center core 40 and the inner peripheral surfaces of the second conductors 21 is narrow, the adhesive 65 may be interposed in the narrow portion to contribute to the fixed installation of the center core 40 to the conductor assemblies 10, . . . , 10. By adopting such a configuration, the durability of the coil device 1 can be improved, or the characteristics of the coil device 1 can be maintained.

Once the plurality of conductor assemblies 10, . . . , 10 and the center core 40 are assembled, next, the exterior member 50 is formed therearound (step S4). The exterior member 50 is formed by any molding method such as die molding, transfer molding, or compression molding.

Once a component in which the conductor assemblies 10, . . . , 10 and the center core 40 are covered by the exterior member 50 is formed in the exterior member forming step (step S4), next, the magnetic member 60 is formed (step S5). The magnetic member 60 may be formed by forming a recess between the first electrode surface 151 and the second electrode surface 251 corresponding to each of the conductor assemblies 10, . . . , 10, disposing the material of the magnetic member 60 in the recess by a method such as application, printing, or lamination, and hardening the material of the magnetic member 60.

The recess between the first electrode surface 151 and the second electrode surface 251 may be formed, for example, by forming a protrusion corresponding to the recess on a die or the like in the step of forming the exterior member 50 or by performing polishing, laser irradiation, etching, or the like after the exterior member 50 is molded.

Once the magnetic member 60 is formed, polishing of the first electrode surface 151 and the second electrode surface 251 may be performed as necessary.

The description above provides one example of the method for manufacturing the coil device 1 according to the present disclosure; further, electrodes may be appropriately formed on the first terminal portions 150 and 150 and the second terminal portions 250 and 250 as necessary.

The coil device 1 of the present embodiment is manufactured, for example, by such a method.

As described above, in the coil device 1 of the present embodiment, since the magnetic member 60 is disposed between the first electrode surface 151 and the second electrode surface 251 on the mounting-side surface 1b joined to a mounting surface of a circuit board or the like when the coil device 1 is mounted on the circuit board or the like, leakage magnetic flux (leakage inductance) from this portion can be reduced, and the magnetic coupling between the first conductor 11 and the second conductor 21 can be enhanced. The portion in which the magnetic member 60 is disposed is a minute region between the first electrode surface 151, the second electrode surface 251, and the insulating member 30 in the vicinity of the mounting-side surface 1b of the coil device 1; however, since the absolute amount of leakage magnetic flux also increases when a high current flows, it is effective to be able to reduce leakage magnetic flux from this portion.

In addition, in the coil device 1 of the present embodiment, since the first electrode surface 151 and the second electrode surface 251 are disposed with the expanded spacing portion 35, in which the spacing between the first conductor 11 and the second conductor 21 is increased, sandwiched therebetween, reduction of leakage magnetic flux (leakage inductance) from this portion (between the first electrode surface 151 and the second electrode surface 251) is even more important. In the coil device 1 of the present embodiment, since the magnetic member 60 is disposed in this portion, reduction of leakage magnetic flux (leakage inductance) is even more effectively realized.

In addition, in the coil device 1 of the present embodiment, since the magnetic member 60 is disposed on the outer side (mounting-side surface 1b side) of the insulating member 30 disposed between the first conductor 11 and the second conductor 21, deterioration of the insulating member 30 can be prevented. That is, when the magnetic member 60 is not present, the insulating member 30 is exposed to the outside, and therefore, the insulating member 30 is exposed to the environmental atmosphere regardless of whether the coil device is before use (before mounting) or after use (after mounting). Therefore, gases in the environmental atmosphere or mechanical forces may act on the insulating member 30, thereby deteriorating the insulating member 30. In addition, the insulating member 30 may deteriorate due to heat applied when the coil device is mounted on a circuit board by soldering. However, in the coil device 1 of the present embodiment, since the magnetic member 60 is disposed on the outer side (mounting-side surface 1b side) of the insulating member 30, the environmental atmosphere, heat, or mechanical force can be prevented from directly acting on the insulating member 30 from the mounting-side surface 1b side (from the outside) , and deterioration of the insulating member 30 can be properly prevented.

In addition, in the coil device 1 of the present embodiment, the insulating member 30 functions as an adhesive for bonding the first conductor 11 and the second conductor 21. By disposing the magnetic member 60 on the outer side (mounting-side surface 1b side) of the insulating member 30, the environmental atmosphere, heat, mechanical force, or the like can be prevented from directly acting on the insulating member 30 serving as an adhesive member from the mounting-side surface 1b side, and deteriorating the bonding effect, and the joined state between the first conductor 11 and the second conductor 21 can be properly maintained.

In addition, in the coil device 1 of the present embodiment, the thermal conductivity of the magnetic member 60 is set to be higher than that of the insulating member 30 by using a resin material containing metal magnetic powder as the material of the magnetic member 60. As a result, heat dissipation from the inside to the outside of the coil device can be enhanced, and a coil device suitable for high-current applications can be realized.

### Modification Examples

It should be noted that the present disclosure is not limited to the embodiment described above, and can be modified in various ways within the scope of the present disclosure.

For example, in the embodiment described above, the magnetic member 60 is formed only between the first electrode surface 151 of the first conductor 11 and the second electrode surface 251 of the second conductor 21 of each individual conductor assembly 10 (as illustrated in FIG. 1B, the portion between the first electrode surface 151 and the second electrode surface 251 along the X-axis direction). However, the magnetic member 60 may be further formed in other parts on the bottom surface (mounting-side surface) 1b of the coil device 1. For example, the magnetic member 60 may be formed in a region in proximity to the portion between the first electrode surface 151 and the second electrode surface 251.

Specifically, for example, as illustrated in FIG. 3A, with respect to the plurality of conductor assemblies 10, . . . , 10 arranged in the predetermined direction (Y-axis direction in FIG. 3A), the magnetic member 60 may be disposed (formed) in a region 611 defined so as to be continuous in the arrangement direction (Y-axis direction) of the conductor assemblies 10, . . . , 10 across the space “between the first electrode surfaces 151 and the second electrode surfaces 251” on one side of the plurality of conductor assemblies 10, . . . , 10 and in a region 612 defined so as to be continuous in the arrangement direction (Y-axis direction) of the conductor assemblies 10, . . . , 10 across the space “between the first electrode surfaces 151 and the second electrode surface 251s” on the other side of the plurality of conductor assemblies 10, . . . , 10.

When the magnetic member 60 is formed in such a manner, as illustrated in FIG. 3B, the magnetic member 60 is formed not only on the bottom surface 1b side (outer side) of the insulating member 30 disposed between the first conductor 11 and the second conductor 21, but also on the outer side of the bottom surface 50b of the exterior member 50 disposed between the plurality of conductor assemblies 10, . . . , 10, so that leakage magnetic flux (leakage inductance) from the bottom surface 1b of the coil device 1 can be reduced over a wide range.

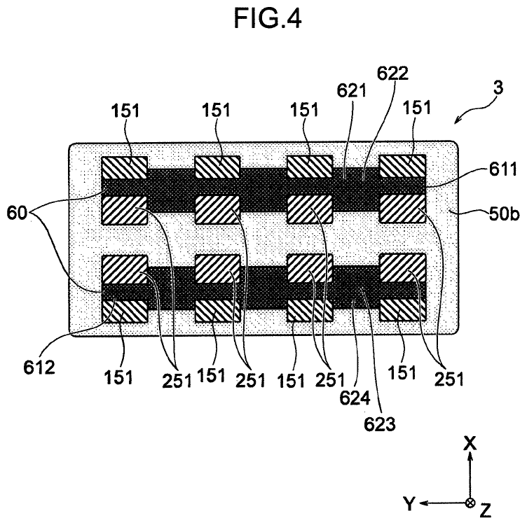

In addition, the formation range of the magnetic member 60 may be further expanded. That is, in addition to the regions 611 and 612 illustrated in FIG. 3A, as illustrated in FIG. 4, the magnetic member 60 may be formed in a region 621 between the first electrode surfaces 151 on the one side of adjacent conductor assemblies 10 and 10, a region 622 between the second electrode surfaces 251 on the one side, a region 623 between the first electrode surfaces 151 on the other side, and a region 624 between the second electrode surfaces 251 on the other side. As one example, each of the regions 621 to 624 illustrated in FIG. 4 defines a part of the region between the electrodes that is closer to the regions 611 and 612, but may define the entire region between the electrodes.

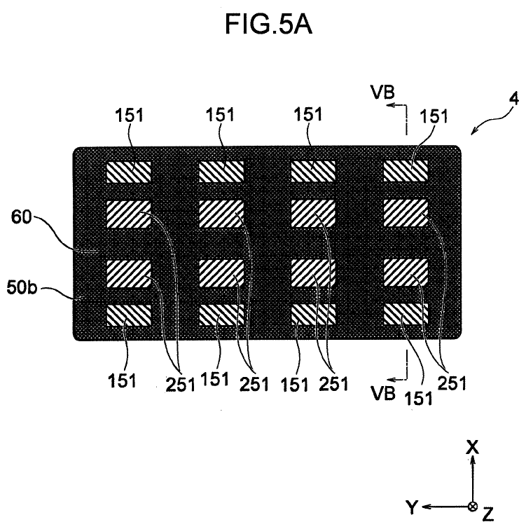

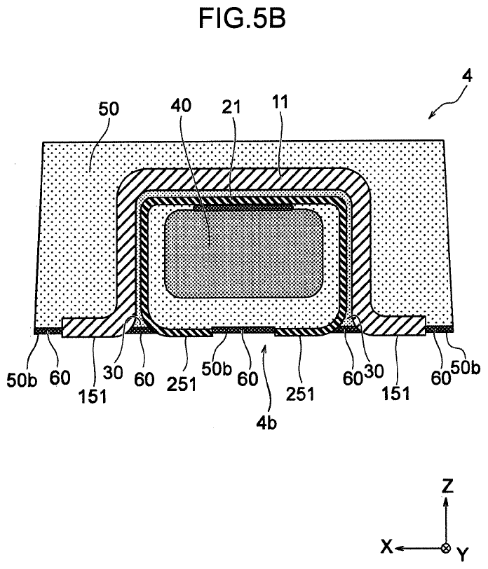

Further, as illustrated in FIGS. 5A and 5B, the magnetic member 60 may be formed over the entirety of the bottom surface 50b of the exterior member 50 on the bottom surface 1b of the coil device 1. In this configuration, the exterior member 50 is not exposed on the bottom surface 1b of the coil device 1. Therefore, this configuration is effective when it is additionally desired to protect the bottom surface 50b of the exterior member 50.

In each of the configurations illustrated in FIGS. 4 and 5A as well, leakage magnetic flux (leakage inductance) from the bottom surface 1b of the coil device 1 can be reduced over an even wider range, and the magnetic coupling between the first conductor 11 and the second conductor 21 can be even further enhanced.

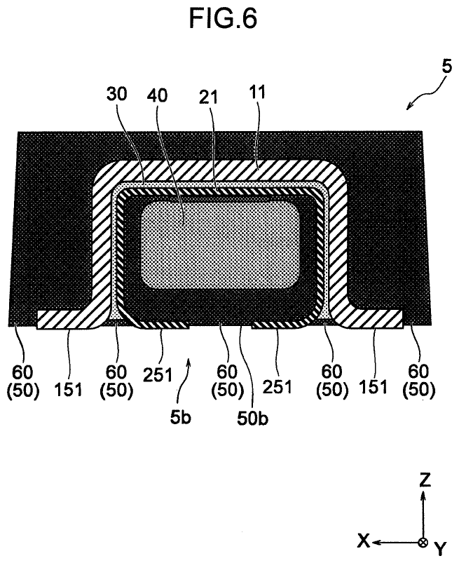

In addition, as illustrated in FIG. 6, the exterior member 50 may be configured using the same material as the magnetic member 60. That is, the materials of the exterior member 50 and the magnetic member 60 may be the same. When such a configuration is adopted, the step of molding the exterior member 50 (step S4 and FIG. 2) and the step of forming the magnetic member 60 (step S5) can be performed in a single step, and therefore, the manufacturing efficiency of the coil device 1 can be improved.

In addition, in the embodiment described above, the first conductor 11 includes the outwardly bent portions 142 and 142, at which the extending direction bens outward, at the end portions of the main body portion 120, and includes the first terminal portions 150 and 150 at the further end portions of the outwardly bent portions 142 and 142. In addition, the second conductor 21 includes the inwardly bent portions 243 and 243, at which the extending direction bends inward, at the end portions of the body portion 220, and includes the second terminal portions 250 and 250 at the further end portions of the inwardly bent portions 243 and 243. However, the configurations of the first terminal portions 150 and 150 and the second terminal portions 250 and 250 of the first conductor 11 and the second conductor 21 are not limited thereto.

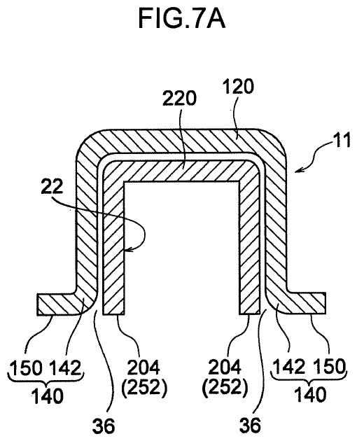

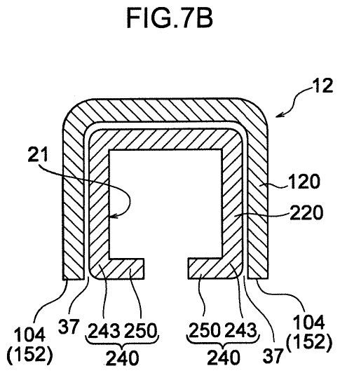

For example, as illustrated in FIG. 7A, the second conductor may be configured as a second conductor 22 in which inwardly bent portions are not provided and both end portions of the body portion 220 extend linearly, as they are, to the bottom surface of the coil device. In this case, both end surfaces 204 of the second conductor 22 are exposed on the bottom surface of the coil device and are configured as second electrode surfaces 252 as they are. In addition, similarly to the embodiment described above, since an expanded spacing portion 36 is formed at the location of the outwardly bent portion 142 of the first conductor 11, the magnetic member 60 may be disposed at the end portion of the insulating member 30 in the expanded spacing portion 36.

In addition, as illustrated in FIG. 7B, the first conductor may be configured as a first conductor 12 in which inwardly bent portions are provided and both end portions of the body portion 120 extend linearly, as they are, to the bottom surface of the coil device. In this case, both end surfaces 104 of the first conductor 12 are exposed on the bottom surface of the coil device and are configured as first electrode surfaces 152 as they are. In addition, similarly to the embodiment described above, since an expanded spacing portion 37 is formed at the location of the inwardly bent portion 243 of the second conductor 21, the magnetic member 60 may be disposed at the end portion of the insulating member 30 in the expanded spacing portion 37.

In addition, in the embodiment described above, the coil device 1 includes the four conductor assemblies 10, . . . , 10, but may be a coil device composed of a single conductor assembly 10.

In addition, in the embodiment described above, the exterior member 50 is formed by compression molding; however, the exterior member 50 may be configured as, for example, an assembly-type case. In that case, the gap between the outer periphery of the conductor assembly 10 and the inner peripheral surface of the case is preferably kept as small as possible such that no voids or the like are formed between the conductor assembly 10 and the case.

In addition, the coil device according to the present disclosure may further include terminal electrodes. Conductive members may be further connected to the first electrode surface 151 of the first conductor 11 and the second electrode surface 251 of the second conductor 21 to serve as terminal electrodes.

### Supplementary Notes

As can be understood from the above description, the present specification discloses the following.

[1] A coil device includes a first conductor having a first electrode surface at an end portion of the first conductor; a second conductor having a second electrode surface at an end portion of the second conductor; an insulating member disposed between the first conductor and the second conductor; and an exterior member covering the first conductor and the second conductor such that at least the first electrode surface and the second electrode surface are exposed to an outside. A magnetic member is disposed on an outer side of an end portion of the insulating member that is close to the first electrode surface and the second electrode surface.

[2] In the coil device according to [1], the magnetic member is continuously formed along a mounting-side surface of the coil device so as to cover the end portion of the insulating member at the mounting-side surface on which the first electrode surface and the second electrode surface are exposed to the outside.

[3] In the coil device according to [1], the magnetic member further includes a portion disposed on the outer side of at least a part of an end surface of the exterior member that is close to the first electrode surface and the second electrode surface, and the portion is integrally connected to the exterior member.

[4] In the coil device according to [1], the magnetic member is formed in a layered manner along a mounting-side surface of the coil device, on which the first electrode surface and the second electrode surface are exposed to the outside, with at least a range including at least a space between the first electrode surface and the second electrode surface.

[5] In the coil device according to [4], the magnetic member is disposed on substantially an entirety of the mounting-side surface, excluding portions of the first electrode surface and the second electrode surface, and the exterior member is not exposed to the outside on the mounting-side surface.

[6] In the coil device according to [1], the magnetic member is integrally connected to the exterior member along a mounting-side surface of the coil device on which the first electrode surface and the second electrode surface are exposed to the outside.

[7] In the coil device according to [1], the magnetic member has an exposed surface substantially parallel to the first electrode surface or the second electrode surface, and the exposed surface of the magnetic member, the first electrode surface, the second electrode surface, and a bottom surface of the exterior member are continuous with each other along a mounting-side surface of the coil device on which the first electrode surface and the second electrode surface are exposed to the outside.

[8] In the coil device according to [1], the magnetic member has an exposed surface substantially parallel to the first electrode surface or the second electrode surface, and the exposed surface is recessed from the first electrode surface and the second electrode surface.

[9] In the coil device according to [1], a material of the magnetic member is the same as a material of the exterior member.

[10] In the coil device according to [1], the magnetic member contains metal magnetic powder.

[11] In the coil device according to [1], the first conductor extends inside the exterior member. The second conductor is disposed inside the first conductor, and at least a part of the second conductor extends along the first conductor. The first electrode surface at the end portion of the first conductor and the second electrode surface at the end portion of the second conductor corresponding to the end portion of the first conductor are exposed in proximity to each other on a mounting-side surface of the coil device as a pair of conductor electrode surfaces. The magnetic member is disposed between the pair of conductor electrode surfaces.

[12] In the coil device according to [11], an expanded spacing portion in which a spacing between the first conductor and the second conductor is larger than a spacing between the first conductor and the second conductor at a position spaced apart from the pair of conductor electrode surfaces is formed between the first conductor and the second conductor at a position close to the pair of conductor electrode surfaces. The magnetic member is formed on the expanded spacing portion.

[13] In the coil device according to [12], the end portion of the first conductor includes an outwardly bent portion bent outward, and the first electrode surface is formed at the end portion of the first conductor so as to be continuous with the outwardly bent portion. The end portion of the second conductor includes an inwardly bent portion bent inward, and the second electrode surface is formed at the end portion of the second conductor so as to be continuous with the inwardly bent portion. The expanded spacing portion is formed between the outwardly bent portion and the inwardly bent portion.

[14] In the coil device according to any one of [1] to [13], a plurality of conductor assemblies, each including the first conductor, the second conductor, the insulating member, and the magnetic member, are integrally covered by the exterior member.

### EXPLANATIONS OF LETTERS OR NUMERALS

1 to 5 COIL DEVICE
1a TOP SURFACE
1b, 2b, 4b, 5b MOUNTING-SIDE SURFACE (BOTTOM SURFACE)
1c1 to 1c4 SIDE SURFACE
10 CONDUCTOR ASSEMBLY
11, 12 FIRST CONDUCTOR
104 END SURFACE
120 BODY PORTION
140 END PORTION
142 OUTWARDLY BENT PORTION
150 FIRST TERMINAL PORTION
151 FIRST ELECTRODE SURFACE
21, 22 SECOND CONDUCTOR
204 END SURFACE
220 BODY PORTION
240 END PORTION
243 INWARDLY BENT PORTION
250 SECOND TERMINAL PORTION
251 SECOND ELECTRODE SURFACE
30 INSULATING MEMBER
31 END PORTION
34 INSULATING GAP PORTION
35, 36, 37 EXPANDED SPACING PORTION
40 CENTER CORE
50 EXTERIOR MEMBER
50a TOP SURFACE
50b BOTTOM SURFACE
50c1 to 50c4 SIDE SURFACE
60 MAGNETIC MEMBER
61 EXPOSED SURFACE
611, 612, 621 to 624 REGION FOR FORMING MAGNETIC MEMBER
71 UPPER DIE
75 LOWER DIE
76 RECESS
83 MATERIAL FOR INSULATING MEMBER

1. A coil device comprising:
a first conductor having a first electrode surface at an end portion of the first conductor;
a second conductor having a second electrode surface at an end portion of the second conductor;
an insulating member disposed between the first conductor and the second conductor; and
an exterior member covering the first conductor and the second conductor such that at least the first electrode surface and the second electrode surface are exposed to an outside,
wherein a magnetic member is disposed on an outer side of an end portion of the insulating member that is close to the first electrode surface and the second electrode surface.

2. The coil device according to claim 1,
wherein the magnetic member is continuously formed along a mounting-side surface of the coil device so as to cover the end portion of the insulating member at the mounting-side surface on which the first electrode surface and the second electrode surface are exposed to the outside.

3. The coil device according to claim 1,
wherein the magnetic member further includes a portion disposed on the outer side of at least a part of an end surface of the exterior member that is close to the first electrode surface and the second electrode surface, and the portion is integrally connected to the exterior member.

4. The coil device according to claim 1,
wherein the magnetic member is formed in a layered manner along a mounting-side surface of the coil device, on which the first electrode surface and the second electrode surface are exposed to the outside, with at least a range including at least a space between the first electrode surface and the second electrode surface.

5. The coil device according to claim 4,
wherein the magnetic member is disposed on substantially an entirety of the mounting-side surface, excluding portions of the first electrode surface and the second electrode surface, and the exterior member is not exposed to the outside on the mounting-side surface.

6. The coil device according to claim 1,
wherein the magnetic member is integrally connected to the exterior member along a mounting-side surface of the coil device on which the first electrode surface and the second electrode surface are exposed to the outside.

7. The coil device according to claim 1,
wherein the magnetic member has an exposed surface substantially parallel to the first electrode surface or the second electrode surface, and the exposed surface of the magnetic member, the first electrode surface, the second electrode surface, and a bottom surface of the exterior member are continuous with each other along a mounting-side surface of the coil device on which the first electrode surface and the second electrode surface are exposed to the outside.

8. The coil device according to claim 1,
wherein the magnetic member has an exposed surface substantially parallel to the first electrode surface or the second electrode surface, and the exposed surface is recessed from the first electrode surface and the second electrode surface.

9. The coil device according to claim 1,
wherein a material of the magnetic member is the same as a material of the exterior member.

10. The coil device according to claim 1,
wherein the magnetic member contains metal magnetic powder.

11. The coil device according to claim 1,
wherein the first conductor extends inside the exterior member,
the second conductor is disposed inside the first conductor, and at least a part of the second conductor extends along the first conductor,
the first electrode surface at the end portion of the first conductor and the second electrode surface at the end portion of the second conductor corresponding to the end portion of the first conductor are exposed in proximity to each other on a mounting-side surface of the coil device as a pair of conductor electrode surfaces, and
the magnetic member is disposed between the pair of conductor electrode surfaces.

12. The coil device according to claim 11,
wherein an expanded spacing portion in which a spacing between the first conductor and the second conductor is larger than a spacing between the first conductor and the second conductor at a position spaced apart from the pair of conductor electrode surfaces is formed between the first conductor and the second conductor at a position close to the pair of conductor electrode surfaces, and
the magnetic member is formed on the expanded spacing portion.

13. The coil device according to claim 12,
wherein the end portion of the first conductor includes an outwardly bent portion bent outward, and the first electrode surface is formed at the end portion of the first conductor so as to be continuous with the outwardly bent portion,
the end portion of the second conductor includes an inwardly bent portion bent inward, and the second electrode surface is formed at the end portion of the second conductor so as to be continuous with the inwardly bent portion, and
the expanded spacing portion is formed between the outwardly bent portion and the inwardly bent portion.

14. The coil device according to claim 1,
wherein a plurality of conductor assemblies, each including the first conductor, the second conductor, the insulating member, and the magnetic member, are integrally covered by the exterior member.
